(19) United States
(12) Patent Application Publication
(10) Pub. No.: US 2014/0048470 A1
(43) Pub. Date: Feb. 20, 2014

(54) System for Treating Water From Induced Hydraulic Fracturing

(71) Applicant: Jason D. Lalli, Washington, PA (US)

(72) Inventor: Jason D. Lalli, Washington, PA (US)

(73) Assignee: ENCOTECH, INC., Eighty Four, PA (US)

(21) Appl. No.: 13/586,486

(22) Filed: Aug. 15, 2012

(51) Int. Cl. C02F 9/12

(52) U.S. Cl. 210/243

(57) ABSTRACT

A system for the treatment of water is provided that may include an oil water separation stage and a photoelectrocatalytic oxidation stage may use ultraviolet light and a photoactive electrode to oxidize at least some of the contaminants and destroy microorganisms in the water. A carbon adsorption stage may also be present that removes residual organic contaminants of the contaminants from the water.

### FIELD OF THE INVENTION

The present invention relates generally to a system for the treatment of water, such as drilling, fracking, flowback, and produced water from an induced hydraulic fracturing process. More specifically, the present application includes a treatment process in which photoelectrocatalytic oxidation is used to treat these waters, and in which the output medium is water having salt content cleansed of contaminants and microorganisms.

### BACKGROUND

Water treatment processes are known for converting contaminated water into potable water or water that is cleaner than that initially introduced into the treatment system. One type of known treatment system is disclosed in U.S. Pat. No. 7,632,416 to Levitt, the contents of which are incorporated by reference herein in their entirety for all purposes. This treatment system incorporates filtration processes and includes a pump that draws contaminated water from a water source into a hydroclone filter that has a filter located within an internal chamber. The filter is arranged in the internal chamber to function as either a cross-flow filter, a stepped filter, or a surface filter. The fluid is transferred through the internal chamber in a vortex type flow pattern such that the fluid flows through the filter and out of an outlet at the bottom of the filter. Water not flowing through the filter may be recirculated back to the internal chamber for subsequent filtering. Filtered water exiting the hydroclone is transferred to a pair of fine filters that filter particles from the water to a desired micron size. After exiting the fine filters, the water is treated at a bacterial control unit, and if drinking water is desired the water is subsequently carbon filtered after exiting the bacterial control unit.

Another known device for treating water is disclosed in United States Patent Publication No. 2009/0314711 to Barry et al., the contents of which are incorporated by reference herein in their entirety for all purposes. This device uses photoelectrocatalytic oxidation to clean water by oxidizing ammonia in the water to nitrogen gas. A photoanode is provided that includes a nanoporous titanium dioxide photocatalyst film coated to a titanium support. The photoanode is submerged in the water that is to be treated. An electrical bias is applied between the photoanode and a cathode to begin the process. A catalyst activator in the form of an ultraviolet light source is applied to the photoanode. The photoelectrocatalytic oxidation process produces hydroxyl radicals and chlorine in the water that removes contaminants.

Induced hydraulic fracturing (fracking) is a mining process in which a well is drilled in order to release natural gas or petroleum from the earth. Explosions cause cracks within the rock and a fracturing fluid is pumped into the well that functions to increase pressure within the well to keep the cracks open. Natural gas and petroleum within the rock are released through these cracks and captured thus increasing the recovery at the well site.

The fracturing fluid is made mostly of water and can include other components such as chemicals, foams, and compressed gases. One use for the inclusion of chemicals in the fracturing fluid is the destruction of bacteria that may grow in the cracks and function to block the flow of natural gas and petroleum through the cracks. After formation of the cracks in the rock structure, pressure in the system can be reduced thus causing the pressure applied by the fracturing fluid to the rock structure to be reduced. Forces in the rock may cause the cracks to close once the pressure of the fracturing fluid is reduced. To prevent the cracks from closing and shutting off the supply of natural gas or petroleum therethrough, the fracturing fluid includes a proppant. The proppant is selected so that it exhibits enough porosity to allow the natural gas and petroleum to flow therethrough, yet exhibits enough strength to resist closure stresses in the rock that function to force the closing of the generated openings. Materials such as glass or sand are used as the proppant in fracking operations.

Flowback through the well consists of the injected fracturing fluid, solids in the well, and water already within the well. The flowback has a high salt content and can include harmful materials. Water associated with fracking such as drilling, flowback, and produced water have high levels of contamination preventing them from being dumped into surface receiving streams. This contaminated water must be treated making disposal both difficult and expensive.

One method of disposal involves pumping the water into a deep well. This technique may prevent the contaminated water from cross-contaminating drinking water, but the potential always remains. Although capable of isolating contaminated water from the environment, the contents of the contaminated water, such as bacteria or suspended solids, function to foul the well and prevent it from being used to dispose of additional contaminated water.

Another approach of handling contaminated water involves treating the contaminated water so that the salt and harmful materials are removed. The contaminated water can be converted into drinking quality water and used or disposed of in a variety of manners. Although capable of disposing of contaminated water, the removal of salt from water is an extremely costly and difficult process that is further complicated by the additional materials present in the contaminated water. Conversion of contaminated water into drinking quality water is thus a complex and expensive process.

A yet additional method of disposing of contaminated water involves shipment of the contaminated water away from the drilling and/or disposal site. The method of shipment may be by truck or train in the case of land based wells, or by way of boat in the case of ocean wells. The contaminated water can be injected into a deep well at the desired storage location. Although capable of disposing of contaminated water, this method is costly in that hundreds of thousands of gallons of contaminated water must be transported a great distance from the drilling and/or disposal site. Although various methods are known for disposing of contaminated water from an induced hydraulic fracturing site, there remains room for variation and improvement in the art.

### SUMMARY OF THE INVENTION

In accordance with one aspect of the design, a system for the treatment of water is provided that includes an oil water separation stage. Water that may include contaminants is transferred through the oil water separation stage. A photoelectrocatalytic oxidation stage can be present that includes ultraviolet light and a photoactive electrode. Organic contaminants of the contaminants are oxidized and microorganisms of the contaminants are destroyed at the photoelectrocatalytic oxidation stage. A carbon adsorption stage can be present and residual organic contaminants of the contaminants of the water are removed at the carbon adsorption stage.

Another aspect of the present design resides in a system for the treatment of water to convert contaminated water to salt water. The system includes an inlet through which water that has contaminants is transferred. An oil water separation stage can be present and water that includes contaminants is transferred through the oil water separation stage. A filtration stage may be present and the water may be transferred through the filtration stage. A carbon adsorption stage may be included and organic contaminants of the contaminants are removed from the water at the carbon adsorption stage. An outlet through which the water is transferred is included. Salt of the contaminants can be present in the water at the outlet such that the salt concentration of the water at the outlet is at least 500 parts per million.

In accordance with a yet additional exemplary embodiment of the present design, a system for the treatment of water is provided that has a filtration stage through which water is transferred. A photoelectrocatalytic oxidation stage is present that includes ultraviolet light and a photoactive electrode. Organic contaminants of the contaminants are oxidized and microorganisms of the contaminants are destroyed at the photoelectrocatalytic oxidation stage. A clarifier stage is present that has a clarifier tank into which the water is maintained for an amount of time. A self-contained mobile unit that houses the filtration stage, the photoelectrocatalytic oxidation stage, and the clarifier stage may also be included.

The system for the treatment of water, together with its particular features and benefits, will become more apparent from the following detailed description and with reference to the appended drawings.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended figures in which:

FIG. 1 is a schematic view of a system for the treatment of water from induced hydraulic fracturing in accordance with one exemplary embodiment.

FIG. 2 is a continuation of the schematic view of FIG. 1.

FIG. 3 is a continuation of the schematic view of FIG. 2.

FIG. 4 is a top view of a storage container that includes a system for the treatment of water from induced hydraulic fracturing in accordance with one exemplary embodiment.

FIG. 5 is a side view of the storage container and system of FIG. 4.

FIG. 6 is a back perspective view of the storage container and system of FIG. 4.

FIG. 7 is a front perspective view of the storage container and system of FIG. 4.

Repeat use of reference characters in the present specification and drawings is intended to represent the same or analogous features or elements of the invention.

### DETAILED DESCRIPTION OF REPRESENTATIVE EMBODIMENTS

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

It is to be understood that the ranges mentioned herein include all ranges located within the prescribed range. As such, all ranges mentioned herein include all sub-ranges included in the mentioned ranges. For instance, a range from 100-200 also includes ranges from 110-150, 170-190, and 153-162. Further, all limits mentioned herein include all other limits included in the mentioned limits. For instance, a limit of up to 7 also includes a limit of up to 5, up to 3, and up to 4.5.

The present invention provides for a system 10 for the treatment of water. In accordance with certain exemplary embodiments the system 10 is used to treat water from induced hydraulic fracturing in which the water is cleaned and may be reused in the same or subsequent drilling operation. The system 10 may clean the water to such an extent that certain contaminants, such as suspended solids and bacteria, are removed while other contaminants, such as salt, remain in the water after processing. The system may make use of a photoelectrocatalytic oxidation stage 16 that uses ultraviolet light 104 and a photoactive electrode 100 to oxidize contaminants in the water. The system 10 may include a self-contained mobile unit 156 such as a shipping container or a tractor trailer that houses various stages of the process so that the system 10 can be quickly and easily moved to and from a particular drilling and/or disposal location. The use of a photoelectrocatalytic oxidation stage 16 reduces (or eliminates) the amount of chemicals that need to be employed in the treatment process, and the provision of processed water that has a high salt content minimizes the cost of the treatment while at the same time reduces the amount of wastewater that must be removed from the site for subsequent storage or disposal.

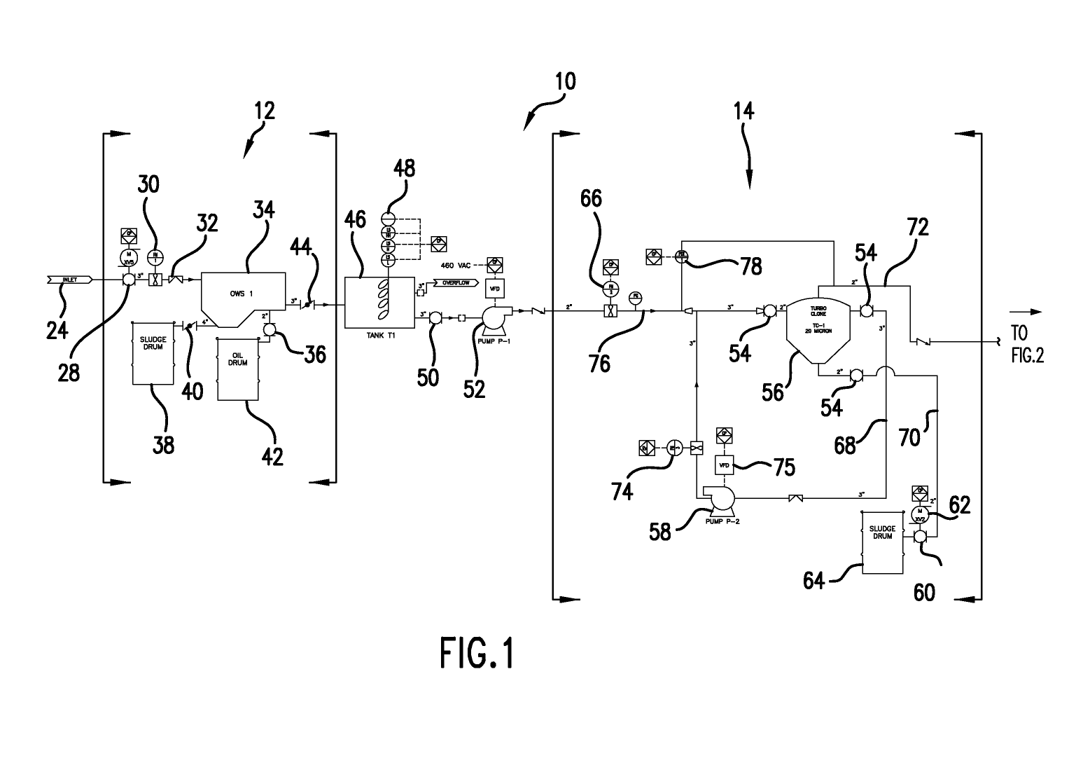

One exemplary embodiment of the system 10 is illustrated in the schematic view of FIG. 1. Water from a fracking operation such as flowback and/or produced water can be introduced into the system 10 through an inlet 24. The water that is input into the inlet 24 may be any type of water obtained in drilling operations such as flowback, fracturing, produced water or drilling water. The water at the inlet 24 may include contaminants such as bacteria, suspended solids, salt, oil, and organics. The water may first flow through a control valve 28, of the form of a butterfly valve, ball valve, solenoid valve, or other, whose opening and closing can be controlled via a control panel to allow and prevent the water from entering the oil water separation stage 12. Upon flowing through the valve 28, the water may flow past a flow meter 30 and then through a flow control valve 32. The flow meter 30 may be responsible for measuring the flow rate of the water at this point in the system 10, and the flow control valve 32 can be opened or closed either automatically or manually by an operator to allow the water to flow therethrough or to prevent the water from moving past the illustrated point in the system 10.

Water that flows through the flow control valve 32 may enter the oil water separator 34. The oil water separator 34 is a gravity separation device that makes uses of differences in the specific gravity between oil and water to effect separation of these components. The oil in the water will rise to the top of the oil water separator 34 and can be skimmed off of the upper surface. This oil can then be transferred through a ball valve 36 and into an oil drum 42 from where it can be subsequently shipped away from the processing site and recycled.

Contaminants in the water that are suspended solids may settle to the bottom of the oil water separator 34 so that the water is located between the upper oil layer and the bottom sediments layer. In some embodiments, the sediments can rest upon a chain and flight scraper that transfers the sediments to a sludge pump for removal from the oil water separator 34. However, it is to be understood that various mechanisms of removing the sediments are possible in accordance with other exemplary embodiments. The sediments may be transferred into a solid waste holding tank 38 through a valve 40. The sediments in solid waste holding tank 38 may be subsequently removed from the processing site and stored or reused as desired. The water after removal of the oil and sediment contaminants can be transferred out of the oil water separator 34 and through a valve 44.

After leaving the oil water separation stage 12, the water can enter a holding tank 46 where it can be held until it is needed for subsequent processing. A plurality of level control switches 48 may be placed into communication with the holding tank 46 in order to provide information on the amount/level of water within the holding tank 46. Although three level control switches 48 are shown, it is to be understood that any number of level control switches 48 may be present in accordance with other exemplary embodiments. For example, from 1 to 5, from 5 to 10, or up to 35 level control switches 48 may be present in accordance with other exemplary embodiments of the system 10. As the level of water in the holding tank 46 increases or decreases, the various level control switches 48 are actuated or unactuated as they are associated with different vertical heights in the holding tank 46.

An overflow mechanism is also included in the holding tank 46 so that water can be vented from the holding tank 46 if it fills to too high of a degree. The water may exit the holding tank 46 and flow to a valve 50 that may be closed to prevent the water from flowing past this point of system 10. The valve 50 may be opened or may be partially opened to regulate the flow of water at this point. The opening, closing, and partial opening of the valve 50 may be done automatically and/or manually.

Once past the valve 50, the water may enter a filtration stage 14 that functions to remove contaminants from the water that are suspended solids. Any type of filter capable of removing solids from water may be employed in the filtration stage 14. In the exemplary embodiment shown, the filtration stage 14 includes a hydroclone based fluid filter 56. In accordance with one exemplary embodiment, the hydroclone based fluid filter 56 may be a “Turboclone”—style filer, as provided by Clean Filtration Technologies, Inc. having offices in Saratoga, Calif.

A feed pump 52 is located at the inlet to the filtration stage 14 and functions to apply pressure to the water to force the water entering the filtration stage 14 through a pressure line 76 at a desired pressure. The feed pump 52 may have a capacity of 60 gallons per minute and may have an operating pressure greater than that of a recirculation pump 58. The feed pump 52 may be an open impeller or solids pump and may be driven by a motor that is five horsepower. Upon exiting the feed pump 52 the water flows past a check valve and across a flow meter 66 that can measure the volume of water flowing through the pressure line 76. In accordance with one exemplary embodiment, the flow meter 66 may have a capacity that is from 2-200 gallons per minute and may be a magnetic type sensor and rated from 12 to 24 volts dc and 4-20 mA. The water is pushed through the pressure line 76 and can be regulated by a valve 54 before introduction into the hydroclone based fluid filter 56.

Upon entering the hydroclone based fluid filter 56, the water pushes a set of brushes that travel around and clean a filter screen that is used to filter contaminants that are suspended solids in the water. The hydroclone based fluid filter 56 is thus self-cleaning in that rotating brushes pushed by the flow of water are used to clean the filter continuously during operation. The filter screen may be sized to be 10 microns, 15 microns, or 20 microns in accordance with different exemplary embodiments. In accordance with yet further exemplary embodiments, the pore size of the filter screen of the hydroclone based fluid filter 56 may be from 1-5 microns, 5-15 microns, 15-30 microns, 30-50 microns, or up to 200 microns in size. The flow rate of the water entering the hydroclone based fluid filter 56 may be from one gallon per minute to 400 gallons per minute in accordance with various exemplary embodiments. Suspended solids that are removed from the water in the hydroclone based fluid filter 56 are exited therefrom out of the bottom of the hydroclone based fluid filter 56 into a solids line 70. A valve 54 may be located in the solids line 70 to regulate the flow of solids through the solids line 70. An additional valve 60 is located downstream from the valve 54 in the solids line 70 and it is associated with a valve actuator 62. The valve actuator 62 may be an electric valve that is powered by a 2.8 amp motor run at 110 volts ac. The valve actuator 62 functions to open and close the valve 60 to regulate the flow of solids in the solids line 70 into a solid waste holding tank drum 64. Solids that are filtered in the filtration stage 14 can be stored within the solid waste holding tank drum 64 and subsequently shipped from the drilling and/or disposal site for storage or recycling.

The filtration stage 14 also includes a recirculation line 68 that is output from the hydroclone based fluid filter 56. Water exiting the hydroclone based fluid filter 56. Water exiting the hydroclone based fluid filter 56 first moves past a valve 54 and then subsequently past a flow control valve.

A recirculation pump 58 is located in the recirculation line 68 and functions to provide pressure to the water in the recirculation line 68 for subsequent transfer back to the hydroclone based fluid filter 56. A variable frequency drive 75 is used to drive the recirculation pump 58 so that it can pump at different speeds. The recirculation pump 58 may have a capacity of 120 gallons per minute and may have an operating pressure of 24 psi in accordance with certain exemplary embodiments. The recirculation pump 58 may be run by a motor that is three horsepower in some arrangements. The pressure of the water pumped by the recirculation pump 58 may be below that of the pressure pumped by the water of the feed pump 52. The recirculation pump 58 functions to push water back into the hydroclone based fluid filter 56 to spin the brushes to clean the filter screen of the hydroclone based fluid filter 56.

A flow sensor/transmitter 74 is located downstream from the recirculation pump 58 and can be a magnetic type sensor having a capacity that is from 2-200 gallons per minute. The flow sensor/transmitter 74 may operate on 12-24 volts dc and 4-20 mA. The flow sensor/transmitter 74 functions to monitor the flow of water through the recirculation line 68 and provide this data to the system 10. The valve 54 and/or flow control valve can be opened or closed or throttled in order to regulate the flow of water through the recirculation line 68 as desired. Output from the recirculation pump 58 is transferred through the recirculation line 68 to merge with the pressure line 76 at which point the output from the combined lines 76 and 68 is input into the hydroclone based fluid filter 56 to spin the brushes and effect filtering of the input water.

The filtration stage 14 also includes a pressure differential transducer 78 that can monitor the differential pressure between the pressure line 76 and a water outlet line 72. The pressure differential transducer 78 may be in fluid communication with the pressure line 76 and the water outlet line 72. Output from the pressure differential transducer 78 can be used by the system 10 in order to control the output of feed pump 52, recirculation pump 58, and valves 54 to regulate the differential pressure or pressure drop in the filtration stage 14. Water that has been filtered by the hydroclone based fluid filter 56 can be output through the water outlet line 72 and past a check valve and out of the filtration stage 14. The pressure differential transducer 78 may have a capacity that is up to 5 pounds per square inch.

The recirculation pump 58 may function to provide water under pressure for the purpose of spinning the brushes in the hydroclone based fluid filter 56. Although described as employing a hydroclone based fluid filter 56, the filtration stage 14 can be provided with any type of filter or filters in accordance with various exemplary embodiments. The filter provided in the filtration stage 14 may be any small pore filter capable of filtering suspended particles from the water. The filter may have a pore size that is from 1-50 microns in accordance with certain exemplary embodiments.

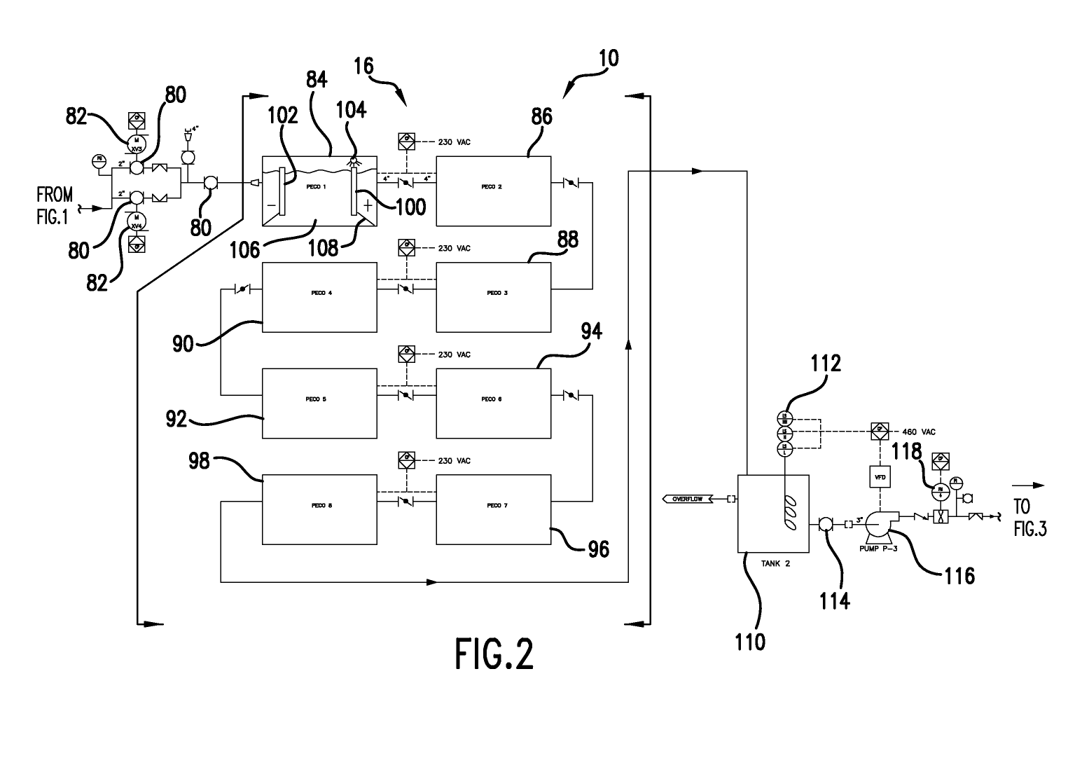

Water that exits the filtration stage 14 may then enter a section of the system 10 that includes valves that are used to control the flow rate of the water at this point. These valves 80 are shown with reference to FIG. 2 in which two valves 80 are placed in parallel arrangement with one and another. The two valves 80 are each controlled by a separate valve actuator 82 that may have a 2.8 amp motor and be operated off of 110 volts ac. The valve actuators 82 can be actuated in order to open, close or partially close the valves 80 as needed. The actuation of the valve actuators 82 may be made automatically or can be performed by an operator of the system 10 as desired. Each of the two parallel lines has a separate flow control valve that is capable of shutting off the flow of water through each one of the lines and these flow control valves may be automatically or manually actuated. The water may converge from the two parallel lines and flow past another valve 80, that can be opened or closed, and into a photoelectrocatalytic oxidation stage 16.

The photoelectrocatalytic oxidation stage 16 functions to remove bacteria, including viruses, and organic chemical contaminants from the water. Organic contaminants in the water will be oxidized into carbon dioxide, water, and constituent products. Contaminants in the water that are hydrocarbons will get broken apart as they will react with other molecules in the photoelectrocatalytic oxidation process. The photoelectrocatalytic oxidation stage 16 may be accomplished without the application of any chemical to the water. The water will flow through eight different units 84, 86, 88, 90, 92, 94, 96 and 98 that are arranged in series with one another as the water flows through the photoelectrocatalytic oxidation stage 16. The photoelectrocatalytic oxidation process will occur in each one of the units 84, 86, 88, 90, 92, 94, 96 and 98 and their configurations may be the same in certain exemplary embodiments.

The configuration illustrated in FIG. 2 may be referred to as a one train, eight stage configuration. However, in other arrangements the various units 84, 86, 88, 90, 92, 94, 96 and 98 may be arranged differently such that the flow of water into the photoelectrocatalytic oxidation stage 16 is split into two lines in which the first line has units 84, 86, 88 and 90 in series with one another, and in which the second line has the other four units 92, 94, 96 and 98 in series with one another. This type of arrangement may be referred to as a two train, four stage arrangement. Other arrangements of the photoelectrocatalytic oxidation stage 16 are also possible. For example, instead of eight units, from 1 to 8 units, from 9-15 units, from 15 to 30 units, or up to 50 units can be employed in other exemplary embodiments. Each one of the units 84, 86, 88, 90, 92, 94, 96 and 98 may be separated by a valve to control the flow of water from one unit to the subsequent unit. Control panels may be in communication with each one of the units 84, 86, 88, 90, 92, 94, 96 and 98 to regulate the photoelectrocatalytic oxidation process for each unit and to potentially control the flow of water out of and into the various units. In other arrangements the flow of water through the various units 84, 86, 88, 90, 92, 94, 96 and 98 is controlled upstream from the photoelectrocatalytic oxidation stage 16 and is not controlled within the photoelectrocatalytic oxidation stage 16.

The photoelectrocatalytic oxidation process includes a photoactive electrode 100, also referred to as a photoanode, that is located within each one of the units. As illustrated in FIG. 2, the photoactive electrode 100 associated with the first unit 84 is shown. Water of the first unit 106 enters the first unit 84 and at least partially submerges the photoactive electrode 100. The photoactive electrode 100 may be made partially or fully of titanium in certain exemplary embodiments. In another exemplary embodiment the photoactive electrode 100 may include titanium dioxide that may be arranged as a thin film that is sintered and nano porous. However, it is to be understood that the titanium dioxide need not be a coating of the photoactive electrode 100 in other embodiments and that the photoactive electrode 100 can be variously configured in other arrangements of the system 10.

The photoactive electrode 100 may have a high surface area and be illuminated with ultraviolet light from an ultraviolet light source 104 that may be above the level of the water in the first unit 106. In other exemplary embodiments, the ultraviolet light source 104 may be submerged either fully or partially within the water in the first unit 106. A cathode 102 is present and is at least partially submerged within the water in the first unit 106. An electrical bias 108 is applied between the photoactive electrode 100 and the cathode 102 and the ultraviolet light from the ultraviolet light source 104 is applied to the photoactive electrode 100 in order to conduct the photoelectrocatalytic oxidation process. The ultraviolet light functions to activate the photoactive electrode 100 to produce highly reactive electron holes. Reactive oxidants are produced at the photoactive electrode that migrate into the water in the first unit 106. The applied electrical bias 108 functions to produce hydroxyl radicals and chlorine that function to remove contaminants from the water in the first unit 106. The photoactive electrode 100 when activated by the ultraviolet light functions as a catalyst in the process. The photoelectrocatalytic oxidation process causes the polymerization of hydrocarbons within the water in the first unit 106. The process may function to oxidize at least some of the contaminants in the water in the first unit 106 without the application of a chemical thereto. As such, in stage 16 no chemicals may be added to the water. The system 10 uses electricity to effect treatment and does not use a lot of chemicals, or in some cases no chemicals, in the treatment process.

Although shown and described with respect to the first unit 84, the ultraviolet light source 104, photoactive electrode 100, cathode 102, and electrical bias 108 may be arranged in similar manners in the second unit 86, third unit 88, fourth unit 90, fifth unit 92, sixth unit 94, seventh unit 96 and eighth unit 98 in the system 10 and a repeat of this information for each one of the units is not necessary. However, the photoelectrocatalytic oxidation process need not be carried out in the same manner in the various units but instead the different units can be configured with different types of photoactive electrodes 100, cathodes 102, ultraviolet light sources 104 and/or different electrical biases 108 in accordance with various exemplary embodiments.

The photoelectrocatalytic oxidation stage 16 may function better in the removal of bacteria and contaminants from the water if the water in the photoelectrocatalytic oxidation stage 16 is saltier. In this regard, it may be the case that salt is not removed from the water before it is placed into the photoelectrocatalytic oxidation stage 16.

The water exiting the photoelectrocatalytic oxidation stage 16 may have contaminants that can be known as flocculent, and in particular suspended flocculent. The water from the photoelectrocatalytic oxidation stage 16 may be transferred into a second holding tank 110 that can be configured in a manner similar to that of the first holding tank 46. The second holding tank 110 includes an overflow and may include a plurality of level control switches 112 for use in determining the level of water in the second holding tank 110. As with the first set of level control switches 48, any number of level control switches 112 can be employed in various arrangements of the system 10. The level control switches 112 function to provide the system 10 with an indication as to the level of water within the second holding tank 110. When the water within the second holding tank 110 is desired to be removed, a valve 114 may be opened to permit its dispensing therefrom.

The water may be pumped by a second feed pump 116 upon flowing through the valve 114. The second feed pump 116 may be controlled by the system 10 and can be activated when a particular level of water within the second holding tank 110 is reached as determined by the level control switches 112. The second feed pump 116 may be a progressive cavity pump that has a ten foot head and a pumping rate of fifty gallons per minute. The use of a progressive cavity pump as the second feed pump 116 may be employed in order to prevent the shredding of flocculent within the water that exits the second holding tank 110. It may be desired at this point in the system 10 to maintain the flocculent within the water so that it can be more efficiently removed.

The second feed pump 116 will push the water through a check valve and past a flow sensor/transmitter 118. A pressure indicator and a valve are included in the line downstream from the flow sensor/transmitter 118 and along with the flow sensor/transmitter 118 function to control the flow rate of the water that comes out of the second feed pump 116 before transference into a clarifier stage 18 of the system 10.

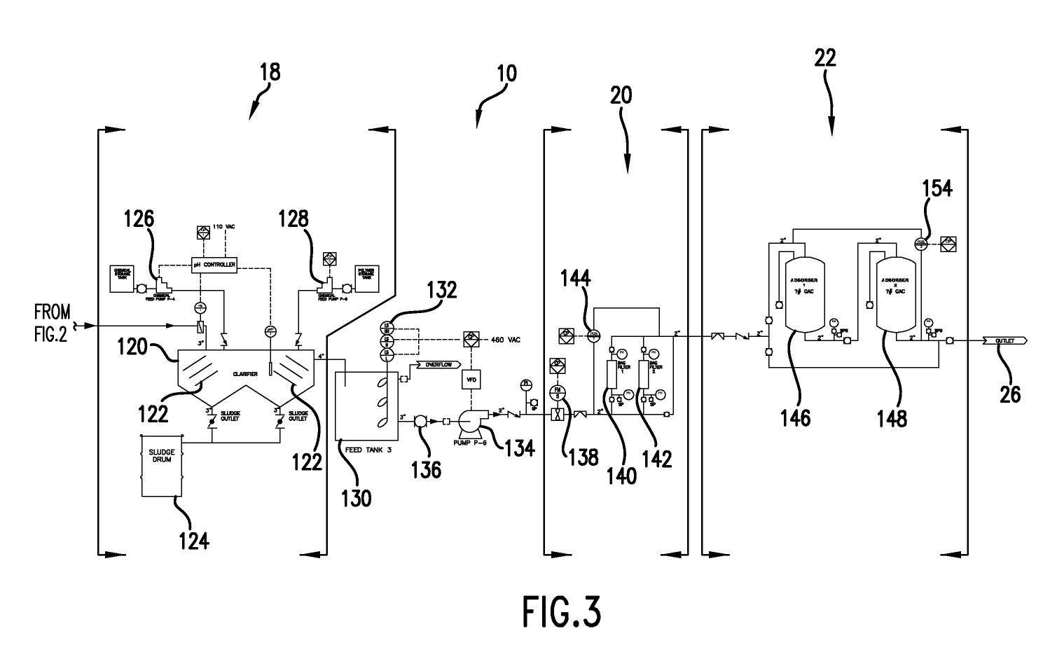

FIG. 3 is a schematic view of the system 10 as the water that is being treated continues from the indicated portion in FIG. 2. Water may flow past a flow sensor and into a clarifier tank 120 of the clarifier stage 18. The clarifier stage 18 may function to remove contaminants from the water that are suspended solids that were not removed in a prior filtering stage. The water may be maintained within the clarifier tank 120 for an amount of time that allows for further oxidation of at least some of the contaminants in the water. The retention time may be sixty minutes in accordance with certain exemplary embodiments. In other exemplary embodiments, the water may sit in the clarifier tank in an amount of time that is from 5-30 minutes, 30-60 minutes, 60-90 minutes, or up to 360 minutes. The clarifier tank 120 may include a plurality of inclined settling plates 122 that function to separate the flocculent from the water as the flocculent engages the inclined settling plates 122 and runs downward after engagement towards the bottom of the clarifier tank 122. The inclined settling plates 122 thus aid in the settling of the flocculent contaminants in the water. The inclined settling plates 122 can be inclined with respect to a floor of a self-contained mobile unit 156 into which the clarifier tank 120 sits, or inclined with respect to the ground onto which the clarifier tank 120 rests at angles of inclination for example from 10 degrees-30 degrees, 30 degrees-45 degrees, or up to 80 degrees.

An optional chemical addition process may be incorporated into the clarifier stage 18 in order to accelerate the settling of contaminants from the water. A chemical feed pump 126 that may be a diaphragm pump having a capacity of five gallons per minute and driven by a motor that is 110 volts ac may be used to transfer the chemical or chemicals from a chemical storage tank and into the clarifier tank 120. A second chemical feed pump 128 that may be likewise a diaphragm pump having a capacity of five gallons per minute and driven by a motor rated at 110 volts ac can be used to draw a polymer from a polymer storage tank for insertion into the clarifier tank 120. The chemical that may be added to the water in the clarifier tank 120 may be aluminum chlorohydrate and may function to cause the flocculent in the water to clump together so that it may more easily fall into the bottom of the clarifier tank 120. In this regard, the chemicals added by the chemical addition process may function to work as a flocculent aid in that it will enhance the removal of this material from the water. The pH of the water in the clarifier tank 120 can be monitored and the chemical feed pump 126 may dispense the chemical or chemicals into the clarifier tank 120 as needed so that the water in the clarifier tank 120 maintains a pH level within a desired range. Although described as having a chemical addition process, it is to be understood that the clarifier stage 18 need not be provided with this chemical addition process in accordance with other exemplary embodiments.

The clarifier tank 120 may be used to settle out long-chain polymers and additional suspended solids for removal from the water. The bottom of the clarifier tank 120 may be provided with one or more hoppers into which sediments from the water will be retrieved and removed. As shown in FIG. 3, the clarifier tank 120 has a pair of solid waste holding tank outlets through which contaminants removed from the water in the clarifier tank 120 can be removed. These contaminants can be transferred to a second solid waste holding tank drum 124 into which they may be retained for subsequent removal from the drilling and/or disposal site.

The water after having contaminants removed therefrom may exit the clarifier stage 18 and be transferred into a third holding tank 130. The third holding tank 130 may have a plurality of level control switches 132 associated therewith that function to provide the system 10 with an indication as to the level of water within the third holding tank 130. The level control switches 132 may be configured in a manner similar to that of those previously discussed with respect to the level control switches 48 and a repeat of this information is not necessary. Further, an overflow outlet may be associated with the third holding tank 130 to handle water overflow as is necessary. Water within the third holding tank 130 may be removed when desired through a valve 136 to a third feed pump 134.

The third feed pump 134 may have a capacity of sixty gallons per minute and push the water at a pressure that is greater than 35 psi. In some exemplary embodiments, the pressure of the water upon exiting the third feed pump 134 may be 50 psi or 60 psi. The third feed pump 134 may be driven by a five horsepower motor and water output from the third feed pump 134 can be transferred through a check valve and past a pressure indicator and a flow sensor/transmitter 138. The flow sensor/transmitter 138 may be used to monitor and control the flow of water at this point in the system and can be a magnetic type flow sensor/transmitter that operates on 12-24 volts dc at 20 mA. The flow sensor/transmitter 138 may be capable of sensing flow rates that are from 2-200 gallons per minute. At this point in the system, the contaminants may be referred to as floc carryover as this is the name that may be assigned to the contaminants after exiting the clarifier stage 18. The water may next be transferred to a post filtration stage 20 of the system 10. The post filtration stage 20 may be arranged so that it removes contaminants from the water without breaking apart the floc carryover contaminants in the water. In this regard, the floc carryover may be maintained in the water so that it can be more easily removed as opposed to the case in which the flock carryover is broken apart during subsequent filtration. The filter selected for use in the post filtration stage 20 is not a hydroclone based fluid filter in the system 10.

The post filtration stage 20 may include a pair of bag filters 140 and 142 that are arranged in parallel relationship to one another. In accordance with other exemplary embodiments, a single bag filter may be used or up to fifty bag filters may be used in the post filtration stage 20. A pressure differential switch 144 can be present and may be a piston type switch with a capacity that is up to thirty pounds per square inch. The pressure differential switch 144 may be operated at 110 volts ac and 0.7 amps. The pressure differential switch 144 may be in communication with both of the lines of the parallel circuit associated with the bag filters 140 and 142 in order to monitor and control the pressure differential across the circuit. The water will flow into the bag filters 140 and 142 and contaminants in the water such as suspended solids may be removed therefrom. The filtered water will exit the post filtration stage 20 and the filtered contaminants may remain within the filters of the bag filters 140 and 142 for subsequent disposal. Although shown as being arranged in a parallel type configuration, it is to be understood that the bag filters 140 and 142 can be connected in series in accordance with other exemplary embodiments.

Output from the post filtration stage 20 may enter a carbon adsorption stage 22 that functions to remove contaminants that are organic contaminants from the water. The organic contaminants may be molecules including, but not limited to, carbon and hydrogen atoms that are environmental hazards and may serve as a food source for bacteria. The inclusion of these organics in water that is subsequently injected into a well that employs induced hydraulic fracturing may be problematic in that the bacteria will grow and block flow through the cracks formed in the fracturing process; this same fouling is also possible in disposal wells. Removal of the organics may function to remove a food source of the bacteria and thus prevent or minimize the bacteria from growing and subsequently blocking the well.

The carbon adsorption stage 22 may employ a number of adsorbers. A first adsorber 146 and a second adsorber 148 are arranged in series with one another. Water entering the carbon adsorption stage 22 will first enter the first adsorber 146 for filtering of the water. Upon exiting the first adsorber 146 the water will then enter the second adsorber 148 at which point it will be further filtered. The carbon adsorption stage 22 also functions to remove contaminants that are organic contaminants from the water. A pressure differential switch 154 may be in communication with the water upon its insertion into the first adsorber 146 and at its exit from the second adsorber 148. The pressure differential switch 154 may function to monitor and control the pressure differential across this portion of the carbon adsorption stage 22. The pressure differential switch 154 may be a piston type switch that has a capacity up to thirty pounds per square inch. The pressure differential switch 154 may operate at 110 volts ac and 0.7 amps. Although shown as employing two adsorbers 146 and 148, it is to be understood that other exemplary embodiments of the system 10 can be configured so that any number of adsorbers are present. For example from 3 to 10, from 10 to 20, or up to 50 adsorbers may be present in other arrangements of the carbon adsorption stage 22. Further, although disclosed as being connected in series with one another, the various adsorbers may be arranged in a parallel type relationship in other exemplary embodiments. Water flowing out of the second adsorber 148 is transferred across a valve and out of the outlet 26 of the system 10.

The water at outlet 26 at the end of the system 10 may contain contaminants that are salts. The system 10 may be set up so that salt is not removed from the water at any of the described stages of the system 10. As such, the system 10 may be arranged so that none of the stages function to remove contaminants from the water that are salts. The water that exits the system 10 at outlet 26 will have a high salt concentration. However, it is to be understood that in other exemplary embodiments of the system 10 that some or all salt in the water that was first introduced in inlet 24 may be removed and thus not present in the water at outlet 26.

The water at outlet 26 may have a salt concentration that is at least 500 parts per million. In accordance with other exemplary embodiments, the water at the outlet 26 may have a salt concentration that is from 500-30,000 parts per million, from 30,000-50,000 parts per million, or a salt concentration that is greater than 50,000 parts per million. By conducting treatment operations that do not remove salt from the water the system 10 can conduct treatment that is inexpensive and fast. The system 10 may be arranged so that a salt removal step is not present and such that the water that is treated by the system 10 that is present at the outlet 26 is not of drinking water quality. The water at the outlet 26 with a high saline content may be used in the next drill site so that other water need not be inserted into the subsequent drill site. In some embodiments, the water can be treated through the system 10 at such a speed that it may be used in the same drill site from which the water itself was removed. The reuse of water with a high salt content into subsequent wells may not increase the salt content of the water that is subsequently removed from the well because there will be a large volume of water already within the well that will function to dilute the injected high saline water.

There may be an amount of water that is taken at various points between the inlet 24 and the outlet 26 that is not capable of being recycled and must be shipped away from the drilling and/or disposal site for subsequent storage. However, this amount of water may be small in comparison to the amount of water that must be shipped and stored in drilling operations that do not include treatment of the water with the system 10.

As used herein the term “contaminant” is anything that is found in the water other than pure water. For example, salt, bacteria, suspended solids, organic contaminants, and radioactive nucleides may be a contaminant in certain embodiments. Although described as removing contaminants from the water, it is to be understood that some contaminants may remain in the water as it exits the outlet 26 upon traversing through the entire filtration system 10. The water at the outlet 26 is thus not pure H₂O but instead is water that has some amount of contaminants therein.

The water at the outlet 26 as compared to the water first input into the system 10 at the inlet 24 may have a hydrocarbon organic contaminant reduction that is at least 99%, a reduction in free iron that is at least 55%, a reduction in predicted scale that is at least 50%, a reduction in suspended solids that is at least 90%, and at least a 99.99% reduction in cellular activity (bacteria and all other living organisms). The water at the outlet 26 may be clean, clear, saline water. The system 10 may reduce petroleum hydrocarbon concentrations in the water, may reduce suspended solids and scaling potential in the water, and may provide for complete disinfection of bacteria in the water.

The system 10 may be a non-recirculating system in that water enters the inlet 24, is processed, and exits the outlet 26 after being processed and does not reenter the inlet 24. In other exemplary embodiments, the system 10 can be a recirculating system in that the water that exits the outlet 26 can be placed back into the inlet 24 and processed and then returned to the outlet 26.

The system 10 may be housed within a self-contained mobile unit 156 for ease of transport to the drilling and/or disposal site, operation at the drilling and/or disposal site, and subsequent removal from the drilling and/or disposal site once filtration of the water is no longer needed. The self-contained mobile unit 156 may be a shipping container that can be transported by a vessel to an offshore drilling platform for subsequent placement onto the platform for use in filtering water retrieved from the drilling process. In an alternative exemplary embodiment, the self-contained mobile unit 156 may be a tractor trailer that can be transported by a truck on a roadway to a drilling and/or disposal site and left at the site for use in treatment operations. The truck can be used to subsequently remove the trailer 156 from the drilling and/or disposal site once it is no longer desired to treat water at the site.

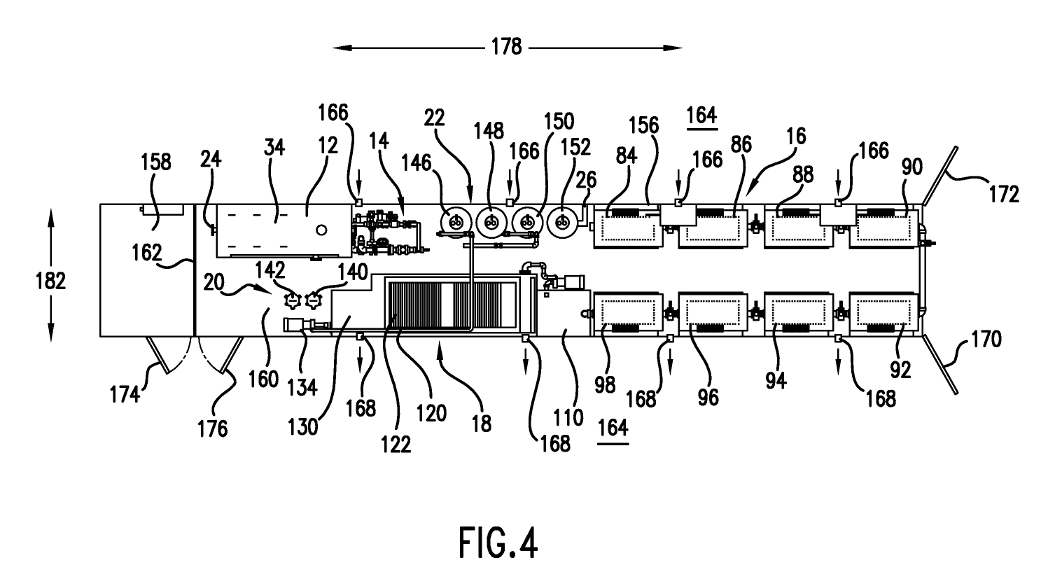

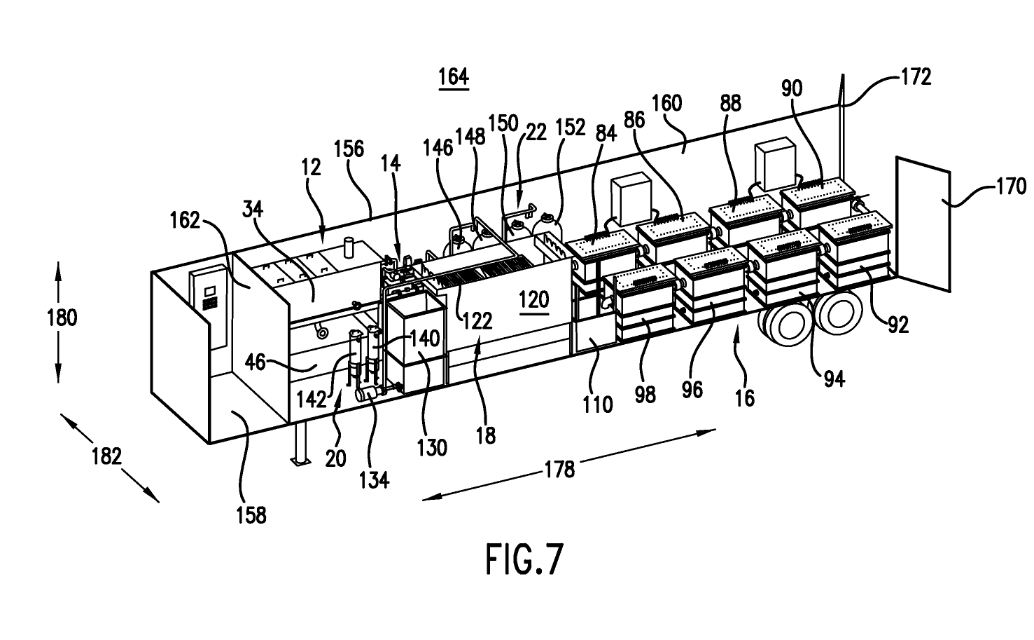

FIGS. 4-7 illustrate one exemplary embodiment of the system 10 that is housed within a self-contained mobile unit 156 that is a tractor trailer. The entire system 10 may be sized and configured so as to fit within the trailer 156 so that the inlet 24 receives water to be filtered and the outlet 26 dispenses water after filtering by the system 10. Waterlines can be connected to the inlet 24 and outlet 26, and electrical power can be connected to the self-contained mobile unit 156 at the drilling and/or disposal site for powering the system 10. The self-contained mobile unit 156 has a second operational space 160 into which the majority of the stages of the system 10 are located. The self-contained mobile unit 156 also contains a first operational space 158 that is separated from the second operational space 160 by a wall 162. An operator may be located within the first operational space 158 to monitor and control the filtering process of the system 10. The first operational space 158 may be an air conditioned room and can be isolated from the second operational space 160 so as to provide protection and comfort to the operator. A door 174 located in a side wall of the self-contained mobile unit 156 can be opened and closed in order to allow the operator to enter and exit the first operational space 158. The first operational space 158 is located forward of the second operational space 160 in the forward/rearward direction 178 of the self-contained mobile unit 156 and has a width that extends across the entire lateral length of the self-contained mobile unit 156 in the lateral direction 182.

The second operational space 160 of the self-contained mobile unit 156 may have a door 176 located in its side wall that affords access into and out of the interior of the second operational space 160 by the operator or other individual. The door 176 is located proximate to the wall 162 and is located slightly rearward of the first operational space 158 in the forward/rearward direction 178. A set of swing out doors 170 and 172 are located at the back end of the second operational space 160 in the forward/rearward direction 178. The swing out doors 170 and 172 may be opened to aid in the insertion and removal of the various stages of the system 10 into and out of the second operational space 160. The doors 170 and 172 can also be used as an access point for the operator or other individual to enter into and exit from the second operational space 160. The components that make up the various stages of the system 10 may be arranged within the second operational space 160 so that a walking space is provided to the operator to allow the operator to physically move from the opening defined by the swing out doors 170 and 172 to the door 176. In this regard, the equipment may be located along the side walls of the second operational space 160 so that the walking space extends through the center of the second operational space 160.

The various stages of the system 10 may be arranged so that the oil water separation stage 12 is located along a right side wall of the second operational space 160 proximate to the first operational space 158 in the forward/rearward direction 178. The filtration stage 14 may be located immediately rearward of the oil water separation stage 12 in the forward/rearward direction 178. The carbon adsorption stage 22 can be located immediately rearward of the filtration stage 14 in the forward/rearward direction 178 and may likewise be located along the right side wall. The photoelectrocatalytic oxidation stage 16 can be the stage of the system 10 that is located most rearward in the forward/rearward direction 178. Four of the units 84, 86, 88 and 90 can be located along the right side wall, and the remaining units 92, 94, 96 and 98 may be located along the left side wall. The second holding tank 110 can be located immediately forward of the eighth unit 98 in the forward/rearward direction 178. The clarifier stage 18 may be located forward of the second holding tank 110 in the forward/rearward direction 178 and may be located along the left side wall of the second operational space 160. The third holding tank 130 is located immediately forward of the clarifier stage 18, and the post filtration stage 20 is located immediately forward of the third holding tank 130 in the forward/rearward direction 178 and is also located immediately rearward of the door 176 in the forward/rearward direction 178 along the left side wall of the second operational space 160.

The water to be treated that flows into the inlet 24 can enter the second operational space 160 in a variety of locations. For example, a hole may be located within the floor of the second operational space 160 and the water to inlet 24 can be piped in through this location. In alternative exemplary embodiments, the water to inlet 24 can be inserted through the ceiling of the second operational space 160 or through one of the side walls of the second operational space 160. Likewise, the water after being treated by system 10 can exit through the outlet 26 through any portion of the second operational space 160 such as the ceiling, floor, side walls, front wall or back wall.

It is to be noted that the carbon adsorption stage 22, that is the last stage of the system 10, is located between the filtration stage 14 and the photoelectrocatalytic oxidation stage 16 in the forward/rearward direction 178 and is thus out of sequence with respect to the other stages of the system 10. Piping that goes along the ceiling of the second operational space 160 may be used to properly direct the flow of water from each one of the stages as needed and to allow for the operator to move through the main room as desired.

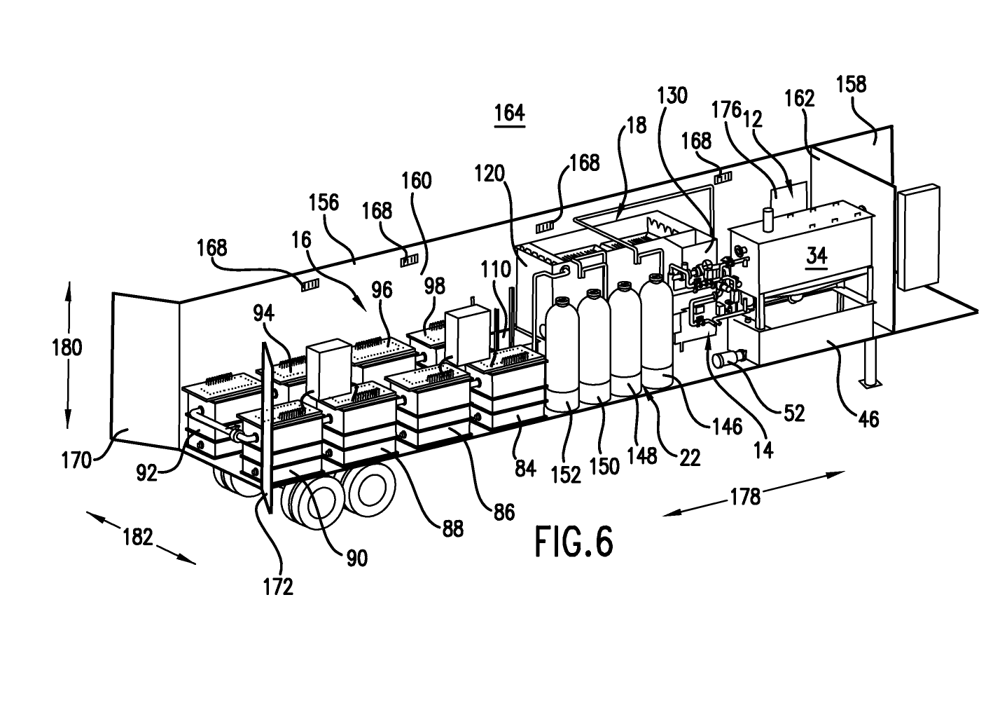

The self-contained mobile unit 156 may be provided with a plurality of air intake vents 166 that are located along the right side wall of the second operational space 160. The air intake vents 166 can be located relatively low within the second operational space 160 in the vertical direction 180. In this regard, the air intake vents 166 may be located proximate to the floor of the second operational space 160. The air intake vents 166 function to draw fresh air from outside 164 of the self-contained mobile unit 156 into the interior compartment of the second operational space 160. The self-contained mobile unit 156 is also provided with a plurality of outtake air vents 168 that are located at the left side wall of the self-contained mobile unit 156. The outtake air vents 168 as shown with reference to FIG. 6 are located relatively high on the left side wall in the vertical direction 180. The outtake air vents 168 may be located higher than the air intake vents 166 in the vertical direction 180. Air within the interior compartment of the second operational space 160 is drawn out of the interior through the outtake air vents 168 and to the outside 164 of the self-contained mobile unit 156. The vents 166 and 168 thus establish an airflow through the second operational space 160 that can function to reduce heat within the second operational space 160 and provide ventilation for the operator. The system 10 can be completely contained within the self-contained mobile unit 156 such that no portion of the system 10 is located outside of or not carried on the self-contained mobile unit 156.

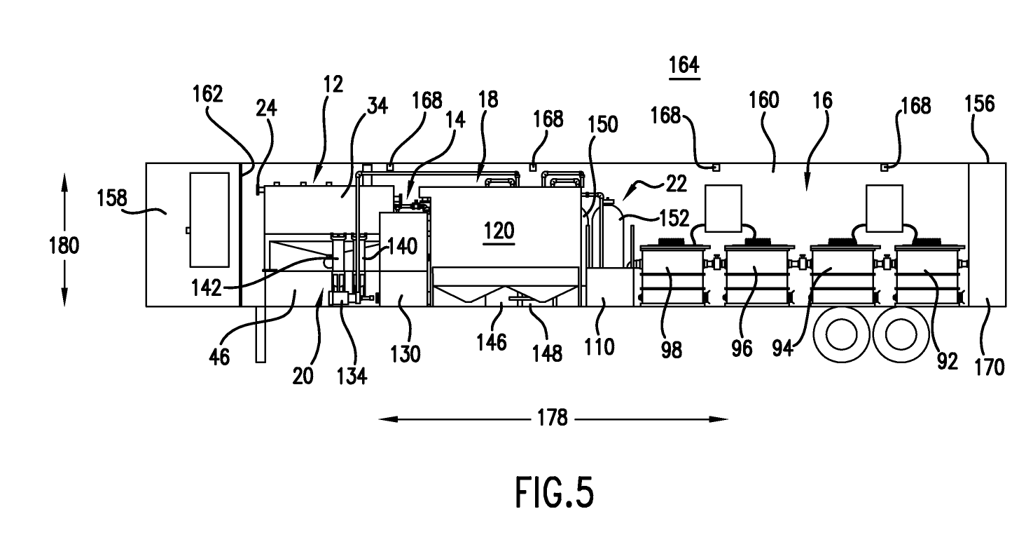

As shown with reference to FIGS. 5 and 6, the holding tank 46 in the oil water separation stage 12 is located under the oil water separator 34. Output from the oil water separator 34 may be dropped into the holding tank 46.

The system 10 may be set up to handle any flow rate of water from the inlet 24 to the outlet 26. In accordance with one exemplary embodiment, the flow rate averages 25 gallons per minute from the inlet 24 to the outlet 26. In accordance with other exemplary embodiments, the flow rate from the inlet 24 to the outlet 26 may be from 15-25 gallons per minute, from 25-35 gallons per minute, or up 50 gallons per minute. In accordance with other exemplary embodiments, the flow rate of water through the system 10 from the inlet 24 to the outlet 26 may be up to 150 gallons per minute. The aforementioned flow rates may be average flow rates from the inlet 24 to the outlet 26.

Although described as treating water associated with a drilling or fracking operation, it is to be understood that the water treatment process and system disclosed herein can be used to treat water associated with any type of operation and is not limited to a fracking or drilling operation in various embodiments.

The items marked CP illustrated on the drawings are control panels that have control inputs on them that can be actuated by a user or automatically to control the items to which they are in communication.

As used herein, the term “salt” is broad enough to include any cation/anion combination. The term “salt” is also broad enough to include chloride compounds such as sodium chloride (table salt). As such, as used herein the term “salt” includes chemical salts and chloride compounds such as sodium chloride, potassium dichromate, sodium chromate, mercury sulfide, and copper sulfate.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

What is claimed:

1. A system for the treatment of water, comprising:
an oil water separation stage, wherein water that includes contaminants is transferred through the oil water separation stage;
a photoelectrocatalytic oxidation stage that includes ultraviolet light and a photoactive electrode, wherein organic contaminants of the contaminants are oxidized and wherein microorganisms of the contaminants are destroyed at the photoelectrocatalytic oxidation stage; and
a carbon adsorption stage, wherein residual organic contaminants of the contaminants of the water are removed at the carbon adsorption stage.

2. The treatment system as set forth in claim 1, wherein the water is flowback from an induced hydraulic fracturing process, wherein the flowback includes injected fracturing fluid and water that was previously within a well before the introduction of the injected fracturing fluid.

3. The treatment system as set forth in claim 1, wherein the carbon adsorption stage is activated carbon adsorption

4. The treatment system as set forth in claim 1, wherein the carbon adsorption stage has at least two adsorbers through which the water is transferred.

5. The treatment system as set forth in claim 1, further comprising a filtration stage that has a hydroclone based fluid filter with a recirculation pump that pumps water to spin brushes of the hydroclone based fluid filter to clean a filtration screen of the hydroclone based fluid filter.

6. The treatment system as set forth in claim 1, further comprising a clarifier stage that has a clarifier tank, wherein the water is maintained in the clarifier tank for an amount of time that allows further oxidation of at least some of the contaminants in the water, wherein the clarifier tank has inclined settling plates, wherein at least one chemical is added to the water in the clarifier stage, wherein at least some of the flocculent of the contaminants is removed from the clarifier tank.

7. The treatment system as set forth in claim 6, further comprising:
a solid waste holding tank that receives suspended solids of the contaminants from the oil water separation stage;
a holding tank that receives the water from the oil water separation stage;
a feed pump that pumps the water received from the holding tank;
a second holding tank that receives the water from the photoelectrocatalytic oxidation stage;
a second feed pump that receives the water from the second holding tank, wherein the second feed pump is a progressive cavity pump and does not shred flocculent of the contaminants in the water when pumping the water;
a third holding tank that receives the water from the clarifier stage; and
a third feed pump that receives the water from the third holding tank.

8. The treatment system as set forth in claim 1, further comprising a post filtration stage that receives the water from the third feed pump, wherein the post filtration stage has a bag filter, wherein the water is transferred from the post filtration stage to the carbon adsorption stage.

9. The treatment system as set forth in claim 1, wherein salt of the contaminants is not removed from the water in the oil water separation stage, the photoelectrocatalytic oxidation stage, or the carbon adsorption stage, and wherein the water output from the carbon adsorption stage has a salt concentration that is at least 500 parts per million.

10. The treatment system as set forth in claim 1, wherein the photoelectrocatalytic oxidation stage includes a plurality of units in series, wherein a plurality of the photoactive electrodes are used, and wherein each one of the units has one of the photoactive electrodes that includes titanium dioxide, and wherein each one of the units has an electrical charge applied thereto, and wherein each one of the units has a reference electrode.

11. A system for the treatment of water to convert contaminated water to salt water, comprising:
an inlet through which water that has contaminants is transferred;
an oil water separation stage, wherein water that includes contaminants is transferred through the oil water separation stage;
a filtration stage, wherein the water is transferred through the filtration stage;
a carbon adsorption stage, wherein organic contaminants of the contaminants are removed from the water at the carbon adsorption stage; and
an outlet through which the water is transferred, wherein at the outlet the water has salt of the contaminants such that the salt concentration of the water at the outlet is at least 500 parts per million.

12. The treatment system as set forth in claim 11, wherein the salt concentration of the water at the outlet is at least 30,000 parts per million.

13. The treatment system as set forth in claim 11, wherein the salt of the contaminants is not removed from the water from the inlet to the outlet.

14. The treatment system as set forth in claim 11, further comprising a photoelectrocatalytic oxidation stage that includes ultraviolet light and a photoactive electrode, wherein organic contaminants of the contaminants are oxidized and wherein microorganisms of the contaminants are destroyed at the photoelectrocatalytic oxidation stage.

15. The treatment system as set forth in claim 11, further comprising a clarifier stage that has a clarifier tank, wherein the water is maintained in the clarifier tank to allow oxidation of at least some of the contaminants in the water, wherein the clarifier tank has inclined settling plates, wherein at least one chemical is added to the water in the clarifier stage.

16. The treatment system as set forth in claim 11, further comprising a self-contained mobile unit that has a first operational space and a second operational space that are separated from one another by a wall, wherein the second operational space has a plurality of intake air vents and at least one outtake air vent, wherein the oil water separation stage, the filtration stage, and the carbon adsorption stage are all located inside of the second operational space.

17. A system for the treatment of water, comprising:
a filtration stage, wherein water is transferred through the filtration stage;
a photoelectrocatalytic oxidation stage that includes ultraviolet light and a photoactive electrode, wherein organic contaminants of the contaminants are oxidized and wherein microorganisms of the contaminants are destroyed at the photoelectrocatalytic oxidation stage;
a clarifier stage that has a clarifier tank into which the water is maintained for an amount of time; and
a self-contained mobile unit that houses the filtration stage, the photoelectrocatalytic oxidation stage, and the clarifier stage.

18. The system for the treatment of water as set forth in claim 17, wherein the self-contained mobile unit is selected from the group consisting of a trailer and a shipping container.

19. The system as set forth in claim 18, wherein the self-contained mobile unit is a trailer and has a first operational space and a second operational space that are separated from one another by a wall, wherein the filtration stage, the photoelectrocatalytic oxidation stage, and the clarifier stage are located in the second operational space, wherein the second operational space has at least one intake air vent and at least one outtake air vent.

20. The system as set forth in claim 17, wherein the water is flowback from an induced hydraulic fracturing process, wherein the flowback includes injected fracturing fluid and water that was previously within a well before the introduction of the injected fracturing fluid.

21. The system as set forth in claim 17, further comprising:
an inlet through which the water is transferred into an interior of the storage container; and
an outlet through which water is transferred out of the interior of the storage container after being transferred through the filtration stage, the photoelectrocatalytic oxidation stage, and the clarifier stage, wherein at the outlet the water has salt of the contaminants such that the salt concentration of the water at the outlet is at least 500 parts per million.
